(19) United States
(12) Patent Application Publication
(10) Pub. No.: US 2003/0107499 A1
(43) Pub. Date: Jun. 12, 2003

(54) Visual display of ground collision avoidance devices for aircraft

(76) Inventors: Gerard Lepere, Velizy (FR); Hugues Meunier, Frouzins (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/129,089

(22) PCT Filed: Sep. 3, 2001
(86) PCT No.: PCT/FR01/02727

(30) Foreign Application Priority Data
Sep. 8, 2000 (FR) 00/11491

(51) Int. Cl. G08B 21/00

(52) U.S. Cl. 340/945

(57) ABSTRACT

The invention concerns a device designed to be installed on board an aircraft to provide eventual warning data corresponding to a risk of collision between the aircraft and the landform. The device comprises an assist-module (4) designed to use static and dynamic parameters of the aircraft with a database of the relief of the terrain flown over (3), and a visual display module (5) for displaying (55) a representation of the relief over a displayed domain, and inserting therein a particular signalling of possible warnings in particular based on a detected landing/take-off phase state.

The invention relates to air navigation aids, especially when there is a risk of collision between an aircraft and the region over which it is flying.

The current proposals for collision avoidance systems include the Ground Collision Avoidance System (GCAS), or the Ground Proximity Warning System (GPWS). These systems have the purpose of warning the pilot that a risk of collision with the ground (or terrain) being flown over may arise. This function is both important and difficult during the approach prior to landing, and after takeoff, and more generally in all cases where the aircraft is necessarily close to the ground.

Patent publications EP-A-0 565 399 and EP-A-0 802 469 disclose air navigation aid systems comprising:

an input for receiving status indications representative of the position and of the velocity vector of the aircraft (at least);

a work memory for storing a representation of the relief of the region overflown by the aircraft;

a processing member, which uses the status indications and the representation of the relief, and from this it defines a Scanned Sector relative to the aircraft and computes, in this sector, various contours according to the intersection of this sector with the representation of the relief; and

a tool for displaying these contours.

The ergonomics of the display are critical. This is because such displays are fitted into the maximum number of civil aircraft and have to supply the pilot with information as clear and easy to interpret as possible, as he may be in a situation requiring his attention elsewhere.

The present invention will improve the situation in this regard.

For this purpose, it provides a system intended to be on board an aircraft and comprising:

an input for receiving static and dynamic parameters of the aircraft;

an aid module designed to use the parameters and at least one overflown terrain relief database so as to extract relief information about a three-dimensional scanned field, defined according to the path of the aircraft, and to generate possible alerting information corresponding to a risk of collision between the aircraft and the relief, depending on at least one predicted path of the aircraft; and

a display module designed to cooperate with the aid module so as to display a two-dimensional representation of the relief on a displayed field and to insert thereinto a possible alert signal.

According to one feature of the invention, the aid module is designed to establish a detected takeoff and/or landing phase state; the aid module is also designed to cooperate with the display module so as to selectively inhibit the possible alert signal (particularly cautions, alarms and predictive information about the latter) over defined portions of the field displayed, in detected takeoff and/or landing phase. The defined portions of the displayed field comprise neighboring portions of the predicted path of the aircraft and neighboring portions of a landing and/or takeoff runway.

According to another feature of the invention, the display module, designed to cooperate with the aid module so as to display a two-dimensional representation of the relief in a displayed field, is capable of inhibiting certain portions of this representation according to a condition comprising the fact that the lowest point of each of these portions is below a chosen altitude and that an aircraft/runway proximity criterion is validated.

Moreover, the invention provides an aid module designed to determine terrain cuts according to a cutting rule which includes several options.

The display module is also designed to represent alert lines according to a chosen mode.

Furthermore, the display module is designed to represent alert areas of different type in a different manner and indicate alert areas on the border of the Scanned Sector in the case of alert areas detected outside the Scanned Sector.

Further features and advantages of the invention will become apparent on examining the detailed description below, and the appended drawings, in which:

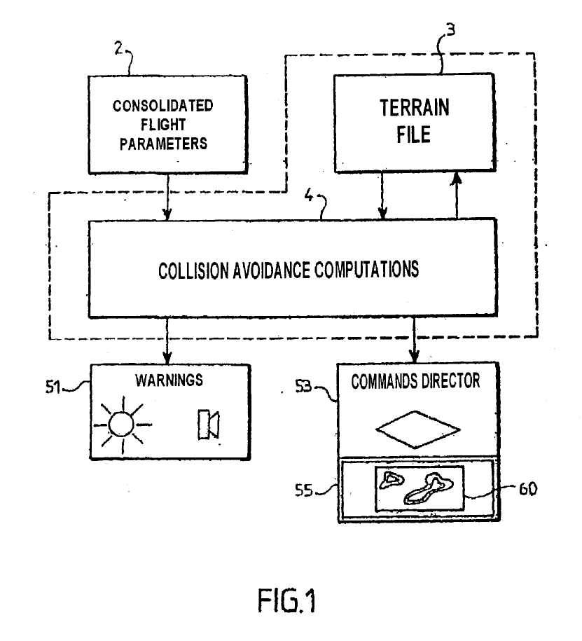

FIG. 1 is a very general block diagram of an air navigation aid system, of the GCAS type, like those described in EP-A-0 565 399 and FR-96/04678;

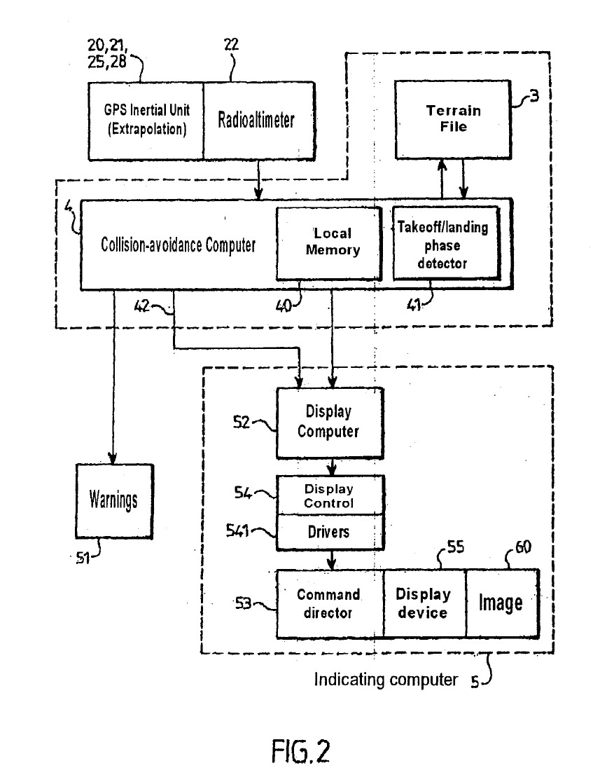

FIG. 2 is a detailed diagram of one embodiment of the system in FIG. 1;

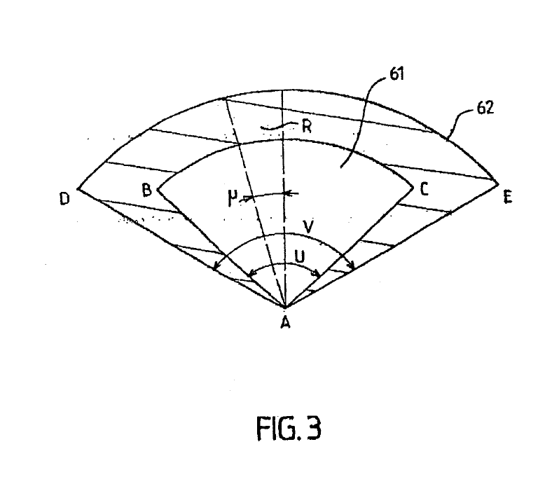

FIG. 3 illustrates an on-screen display of a Scanned Sector and of its delimitation;

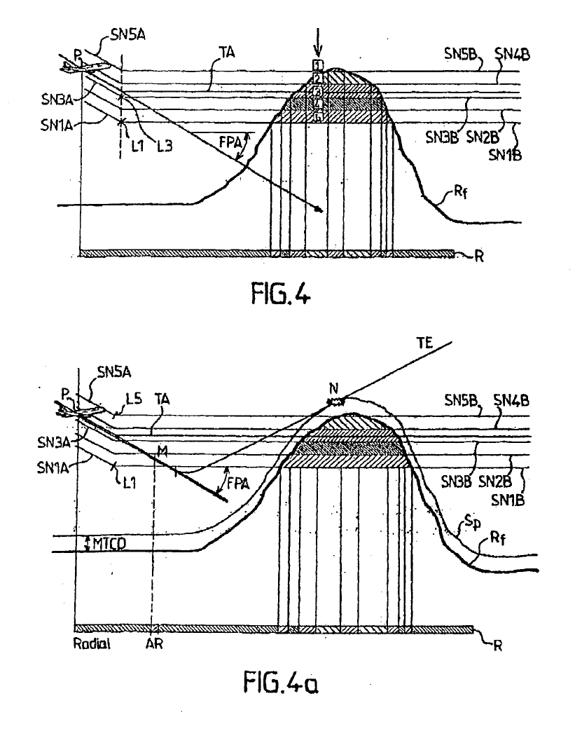

FIG. 4 is a vertical sectional view of an example of terrain overflown by an aircraft and of the corresponding layers of terrain;

FIG. 4a is a view supplementing FIG. 4 by introducing a collision risk detection probe;

FIG. 5 is a vertical section view of another example of terrain overflown by an aircraft, showing the determination of an alerting terrain area of a first type;

FIG. 5a is a vertical sectional view of one particular example of rugged terrain overflown by an aircraft, showing the determination of an alerting terrain area of a first type;

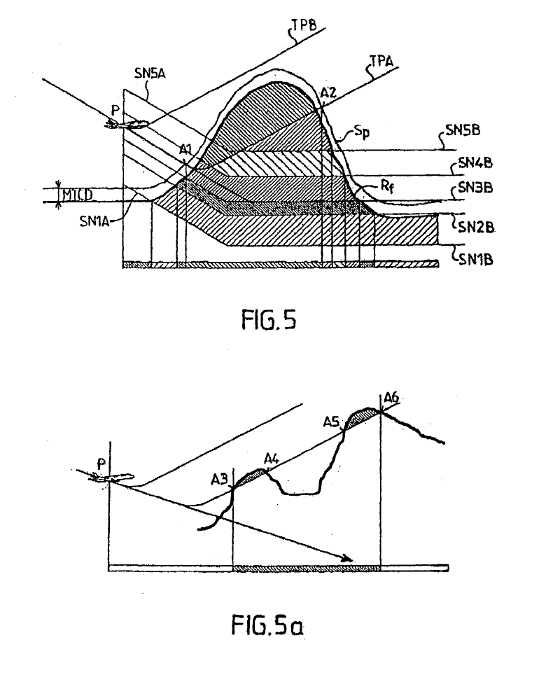

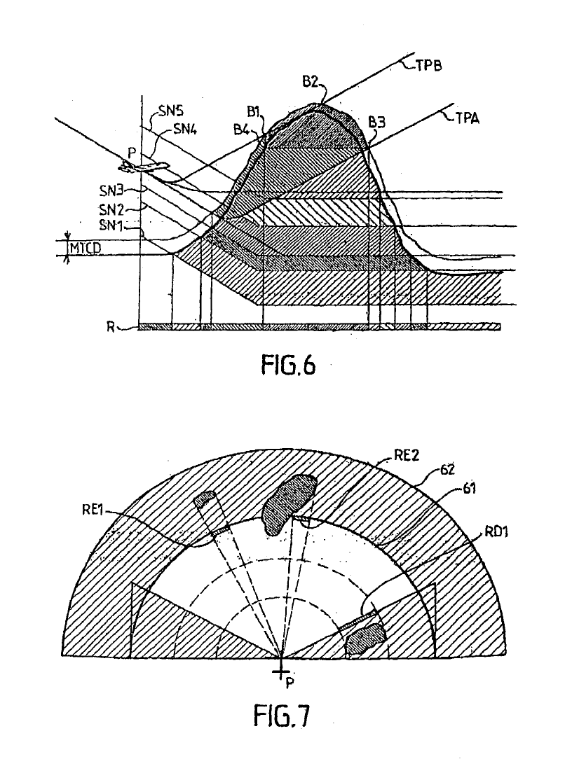

FIG. 6 is a vertical sectional view of a third example of terrain overflown by an aircraft, showing the determination of two alerting terrain areas of different types;

FIG. 7 illustrates an on-screen display, showing a Scanned Sector and displaying alerting terrains lying outside the display region of the Scanned Sector;

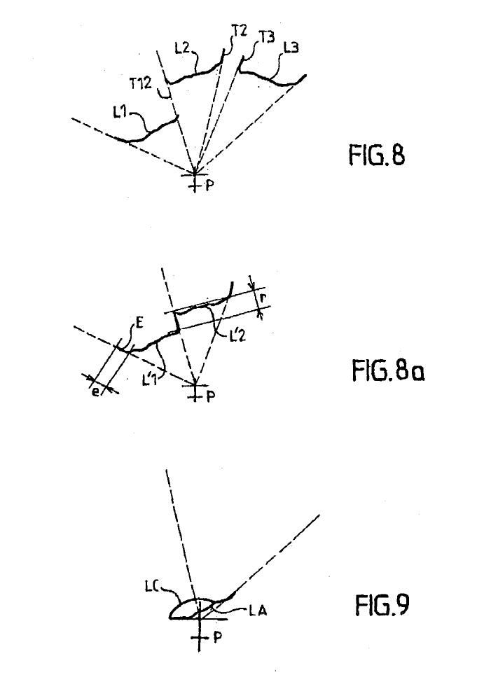

FIG. 8 is a horizontal view illustrating modifications made to the alert lines in the Scanned Sector;

FIG. 8a is a horizontal view illustrating other, complementary modifications made to the alert lines in the Scanned Sector; and

FIG. 9 is a horizontal view illustrating the minimum position of an alert line with respect to an aircraft.

The appended drawings are essentially definitive in nature. Consequently, they may not only allow the detailed description which follows to be more clearly understood, but also help to define the invention, where applicable.

Furthermore, and taking into account the technical aspect of the subject, reference is made to the descriptive contents of EP-A-0 565 399 and EP-A-0 802 469 (arising from FR-96/04678) in order for a person skilled in the art to supplement, where required, the present description. The same applies to the following document:

Dassault Eléctronique Report No. 810-196 AN, published in October 1997, entitled “A New Approach to CFIT Prevention and to improve situational awareness: GCAS GROUND COLLISION AVOIDANCE SYSTEM”.

Use will also be made of units that do not belong to the MKSA system, although they are derived therefrom, insofar as they are essential in civil aeronautics.

Reference will firstly be made to FIGS. 1 and 2 in order to describe a first nonlimiting embodiment of an air navigation aid system to which the invention may apply. As described in EP-A-0 565 399, such a system is essentially intended to be installed on board an aircraft, and especially an airplane. This system comprises equipment 2 capable of delivering flight parameter (especially position and dynamics) indications in the form of electrical signals. This equipment may comprise an inertial or baro-inertial system 20 or INU and/or a radio navigation instrument, in this case a GPS receiver 21 (but it could be an IRS), with its antenna, a radioaltimeter 22, with its antenna, or other onboard navigation probes.

The inertial system 20 delivers the components of the velocity vector (V) of the aircraft and, if applicable, its acceleration vector (Y). From these it is possible to deduce all or some of the associated characteristic angles (especially angle of attack, sideslip angle, angle of glide, angle of pitch, heading angle and roll angle) or to collect directly the values of these angles used internally by the inertial system. These angle values may be displayed and/or used at the flight control station. The same applies, for example, to the acceleration which may be computed or recomputed from the velocity vector. In the case of altitude, the inertial system cooperates in a known manner with a barometric altimeter (not shown).

The GPS receiver 21 delivers crude latitude measurements L1, longitude measurements G1 and altitude measurements Z1, these being refreshed at a rate p1 ranging from a few seconds to a few minutes. By integration over the velocity vectors (and where applicable, the acceleration vectors), the inertial system 20 delivers other latitude L0, longitude G0 and altitude Z0 measurements, these being accurate but drifting over time. A block 25 compares the two types of measurement and validates the quantities L1, G1, Z1 provided that they are consistent with L0, G0, Z0. Such validation techniques are known. The validated measurements L2, G2, Z2 are available at the rate p1. However, they are refined by means of the inertial system at a rate p2 of about one second.

A block 28 extrapolates the information between the last instant of measurement by the instrument 21 and the current instant (this extrapolation is useful, especially when the information is delivered at an insufficiently rapid rate). The radioaltimeter 22 delivers the height over the ground, denoted HOG.

This is used to compute the predicted path of the airplane, together with one or more instantaneous path axes. It will be assumed in the following that only a single instantaneous axis is computed.

A block 3 contains a terrain file. Depending on the L and G values, an extract is obtained from this file. This extract, called a local map, is a three-dimensional representation of the relief of the region overflown by the aircraft. It is stored in a local memory 40.

On the basis of this local map and of the L, G, Z and HOG values, the block 4 performs collision avoidance computations, which may be accompanied by terrain avoidance computations.

When there is a risk of a collision, an alert or alarm 51 is emitted. A command director 53 may suggest, when applicable, an avoidance maneuver. This is sent to the flight control station (or cockpit). The local map may also be used to generate a synthetic image 60 on a display device 55.

The foregoing description is essentially contained in EP-A-0 565 399 and EP-A-0 802 469, which also indicate how to bring together and verify mutually the various items of information available, especially in terms of altitude.

One of the essential foundations of EP-A-0 565 399 is the fact that the Applicant perceived the possibility of storing on board an aircraft a terrain file capable of representing almost the entire Earth's globe, within the contour and resolution limits appropriate for the requirements of an aircraft. In addition, the terrain file may contain precise data relating to runways, their geographical location, their designation and their representation, for example. The landing phase state may be detected by the aid module 4 according to the same indices as those of EP-A-0 565 399.

The notations below will be defined as follows:

Zb is the barometric altitude given by the measurement of the atmospheric pressure; it varies with the altitude and the meteorological conditions;

Zi is the inertial altitude computed by double integration of the vertical acceleration measured by the accelerometers of the inertial system (long-term variations);

Zbi is the baro-inertial altitude, that is to say the Zb value filtered by the Zi value by means of a 3rd-order loop, for example (ZO=Zbi);

Zc is the computed altitude (HOG+Zta), where HOG is the radioaltimeter height (or relative height) given by the aircraft's radioaltimeter or radioaltimeters (accuracy of a few meters), and Zta is the altitude of the terrain beneath the aircraft given by the terrain file (defined later); and

Zgps is the altitude delivered by, for example, the GPS or another suitable instrument (Z1=Zgps).

For the rest of the description, a few other definitions will be useful:

the term “predicted axis” denotes the axis of the (recent) past and predicted path of the aircraft; if the aircraft is in an in-flight turn, this “predicted axis” is a curve;

the term “tangent axis” denotes the tangent to the path of the aircraft in its instantaneous position, that is to say the straight line supporting its instantaneous velocity vector;

the term “instantaneous axis” of the path of the aircraft denotes an axis lying approximately between the tangent axis and the predicted axis and determined, using a predefined rule, for example, by a weighted linear combination of the tangent axis and the predicted axis; thus an instantaneous axis may be defined as the predicted axis, the tangent axis or an intermediate axis between the two; several different instantaneous axes may be defined at the same time;

the term “vertical plane” denotes a surface (not necessarily flat) which contains the vertical passing through the aircraft and an instantaneous axis of the path of the aircraft; as regards the predicted axis, the “vertical plane” is a curved surface if the aircraft is in an in-flight turn; maneuvers whose principal component lies in a vertical plane are called “vertical” maneuvers;

the term “horizontal plane” denotes the horizontal plane passing through a reference point in the aircraft (for example the center of gravity); maneuvers whose principal component lies in a horizontal plane are termed “horizontal” or “lateral” maneuvers; here too, the horizontal “plane” could be a surface curved in space, defined according to the path of the aircraft;

a distinction is made, among horizontal maneuvers, between those going to the left and those going to the right of the predicted path of the aircraft;

finally, the words “vertical” and “horizontal” or “lateral” will also be used especially to qualify the obstacles and the risks which may be encountered during the maneuvers.

An alert may be defined by means of a surface (in fact, a portion of a surface) delimiting a protection region in front of the airplane (more generally around an aircraft) with respect to the terrain. Each protection surface may be seen as a family of curves in space. It is possible to provide:

in the case of a warning, a short-term surface STS, intended mainly to avoid an accident. As soon as a point on the terrain comes into the surface or the upper envelope of the surface, the pilot must react (warning) by immediately carrying out an avoidance maneuver;

in the case of a caution, a medium-term surface MTS, mainly intended to warn the pilot that the path of his aircraft will encounter an obstacle if it continues as it is and that he must envision an avoidance maneuver (caution).

The surfaces used for the warning and the caution are preferably both defined according to the same principle but with different parameters. These protection surfaces may be generated from many static and dynamic parameters of the aircraft, in particular:

the control transfer function of the aircraft, that is to say its maneuverability;

the delays TR0 due to the reaction time of the aircraft's pilot;

the horizontal speed Vh of the aircraft;

the rate of climb Vz of the aircraft;

the permissible load factor n.g;

the stipulated safe height; and

the roll of the aircraft.

According to EP-A-0 565 399 (especially FIG. 6 and the corresponding description), a limiting alert curve in the vertical plane may be defined by four sections:

from T₀ to T₁, the continuation of the predicted path as it is (no new maneuver) for a time equal to a delay RT0=T₁−T₀, corresponding to a reaction time;

from T₁ to T₂, a transition period due to actions to possibly reduce the roll and change the radius of curvature of the path, going from infinity (straight-line flight) to a climb radius R_{T};

from T₂ to T₃, the actual limiting avoidance path, the radius of curvature R_{T} of which is, for example, a direct function of the square of the linear speed Vₕ of the aircraft divided by the load factor n.g actually applied, i.e.

R_{T}=(Vₕ)²/n.g

beyond T₃, a straight sloping line depending on the characteristics (performance) of the aircraft.

For a family of limiting curves of this kind, a surface in space is defined, which will be called here a “probe”. In fact, with digital processing this surface is sampled as a family of curvilinear segments: see especially the text and FIGS. 8A and 8B of EP-A-0 802 469 for further information.

It is conceivable to “fix” the probe or probes with respect to the airplane and look for the intersection of these probes with the terrain, taking a safety margin into account.

It is also possible to use a different procedure, with a “sliding probe”:

firstly a path corresponding to a standard avoidance maneuver in the vertical plane, SVRM (Standard Vertical Recovery Maneuver), is defined;

taking the instantaneous axis of the aircraft's path and/or depending on the orientation of the predicted path (or their linear combinations), it is possible to make the SVRM slide along this axis as far as the point where it encounters the envelope of the terrain;

a vertical reference point VRP or time, which is the start of the SVRM, may then be defined;

upstream of this VRP point on the predicted path, two times VT5 and VT20 are defined with, for example, VT5=VRP−5 seconds, and VT20=VRP−20 seconds; and

a “vertical” caution and a “vertical” warning are then defined, as soon as the aircraft passes the VT20 point and as soon as it passes the VT5 point (of course, the warning “quashes” the caution).

However, cases exist in which, another maneuver being possible, it is normal for the aircraft to exceed the final point for performing the standard avoidance maneuver SVRM. However, beyond this point a “vertical” avoidance maneuver is no longer possible.

It is then possible to define a standard lateral avoidance maneuver (SHRM) which can be initiated in an emergency in order to avoid a risk of collision with the surrounding terrain, with minimum safety margins.

The actual avoidance path SHRM starts at a point HRP lying on the predicted path. Before this point, two anticipated points HT5 and HT20 are provided, these also lying on the predicted path, for example at 5 and 20 seconds upstream of the point HRP respectively, taking into account the present speed of the aircraft. A “horizontal” caution and a “horizontal” warning are then defined, as soon as the aircraft passes the point HT20 and as soon as it passes the point HT5 (of course, the warning “quashes” the caution), respectively.

For the case in which the aircraft is in horizontal flight:

1. the first segment SHRM1 (from t1 to t2) consists of an accentuated turning movement, for example with a turn radius of about 2 NM compatible with the performance of the aircraft;

2. the second segment SHRM2 (from t2 to t3) consists of a continuation of the accentuated turn, so as to come back to the point HRP;

3. a third segment SHRM3 (from t3 to t4) may consist of a repetition of the first two segments (without the turning maneuver), so as to come back to the point HRP, with altitude setting, where applicable.

As regards the lateral avoidance maneuver and for flight situations other than horizontal ones, reference may be made for further details to FR-A-2 747 492, FIGS. 9A to 9D with the corresponding description.

Analysis of the instantaneous and predicted situation of the aircraft then amounts to a number of tests of curves, suitable for generating in principle at least two types of alert:

a warning indicating a configuration requiring an immediate and/or urgent action by the pilot, since the safety of the flight is in jeopardy;

a caution indicating a dangerous medium-term configuration, the caution having an alerting function; and

optionally, an advisory signal or predictive indication, which corresponds to an indication or advice.

Separately or together, these various message levels are called “alerts”. It is usually considered that at least the “caution” and “warning” levels are to be used. To lighten the description, advisory alerts will therefore not be referred to (except in the form of “alert lines”).

The above defines an operating mode of the system on board the aircraft, for the purpose of predicting and warning of potential collisions of the aircraft with the relief. This mode is called CPA (Collision Prediction and Alerting).

The caution and warning signals are manifested in the cockpit in a specific form: alert sounds, flashing lights, voice messages or messages written on a small screen, for example. The vocal or written form allows for greater precision, a distinction being made especially between:

a “pull-up warning” corresponding to the recommendation of a vertical avoidance maneuver; and/or

an “avoid terrain warning” corresponding to the recommendation of a lateral avoidance maneuver.

Technically, the proposed arrangements are satisfactory in most situations that an airplane may have to encounter in flight.

The final aim is to provide the aircraft's pilot with a warning signal if the predicted path leaves him to suppose that there is a certain risk as regards the neighboring overflown terrain, so that the pilot can immediately initiate a maneuver to avoid this terrain with a minimum safety margin. The notion of minimum safety margin should be understood to mean both in terms of human reaction time and in terms of distance with respect to the terrain avoided. The expression “neighboring overflown terrain” takes into account not only the terrain directly encountered on the axis of the aircraft's path, but also its adjacent portions.

One difficulty remains, that of presenting a clear and overall image of the situation to the airplane's pilot.

A priori, it is advantageous for the display to indicate all or some of the following information:

a) situation of the airplane (Background Display for Situation Awareness); this involves showing the relief of the surrounding terrain, the predicted path of the aircraft and its height relative to the relief;

b) alert areas (Caution and Warning Alert areas), which correspond to the geographical areas giving rise to the current alert(s), if one exists;

c) potential alert area limit lines, or “alert lines” in short; an alert line marks an area liable to generate a short-term alert if the airplane enters into one; this information is of the advisory or indicating type; and

d) paths allowing the relief to be avoided.

Although all this information is by nature in three dimensions, it has to be displayed as best as possible on a two-dimensional screen.

The simplest way of representing the surrounding relief consists in using horizontal level curves. However, the Applicant has observed that they can prove to be tricky to interpret. This is especially the case when the aircraft is not moving in a horizontal plane, since the display corresponds less well to the pilot's sensation; this is also the case near airport areas and in rugged regions, where the display may become unnecessarily cluttered.

Moreover, although the pilot knows that the current path of the aircraft runs no risk of touching the relief, he may be distracted by the emission of an alert based on the application of an unsuitable avoidance path which itself touches the relief.

More generally, the information presented, such as the representation of the surrounding relief, the contours defining collision hazards and the representation of the relief associated with these hazards, turns out in certain situations to provide extraneous information which can impair the pilot's reactions and decisions. Thus, the pilot must have the most meaningful display possible in certain situations: particularly rugged overflown relief; technical problems with the aircraft; takeoff and landing. In contrast, during a cruise flight phase, the pilot might be lacking in information about the surrounding hazards if he were to decide not to follow the indication given after a warning. The invention aims in particular to remedy these drawbacks.

The information to be displayed comes from the local memory 40. The detector, which detects the takeoff and landing phases with respect to a runway 41, causes, if these phases are detected, changes to the display, these being described later according to the invention.

To sort this information, the indicating computer 5 comprises (or is joined to) a display computer 52 capable of filtering the information according to defined criteria and of sending it to the display control 54. The latter, via drivers 541, transmits the information to the command director 53 and above all to the display device 55, which generates a synthetic image 60.

The defined filtering criteria are generally geometrical computations corresponding to intersections of surfaces or families of curves. These computed intersections are assigned attributes indicating, for example, their nature: 1000 foot level curve or pull-up warning area, possibly accompanied by the altitude of the collision terrain. In general, it is known how to perform such calculations as soon as the intersection criterion is defined. Likewise, it is known how to convert attributes into a given display form as soon as the latter is defined.

The display device 55 should allow the pilot of the airplane to have the best possible appreciation of the representation of the three-dimensional overflown relief on the basis of a two-dimensional synthetic image 60. The pilot must also be able to anticipate by a horizontal and/or vertical maneuver possible collisions between the aircraft and the overflown relief by means of a display of the possible alert contours in a distinctive terrain contour form. The alert contours define either alert lines, which mark the geographical boundary of a potential collision hazard and anticipate the emission of an alert (caution or warning), or alerting terrain areas which appear after an alert has been triggered.

One of the aims of the invention is for these information representations, essential for the pilot, to be presented so as to be perceived according to their degree of importance at the desired time. Thus, the pilot receives information appropriate to the flight situation without being distracted by their inopportune occurrence, their profusion or their lack of clarity in their display.

In one embodiment, the image presented to the pilot is contained in a Displayed Sector in two dimensions. Moreover, the overflown relief on the one hand, and the possible areas of collision between the aircraft and the overflown relief on the other hand, are determined according to a Scanned Sector in three dimensions, which is preferably greater (in projection) than the Displayed Sector.

The operations required in the Scanned Sector are those which allow:

the display of the terrain itself, in order to have an appreciation of the overflown relief; a new cut of the terrain is described later according to the invention;

when there is an alert, the marking of the intersection between the terrain and the probe surface which has given rise to the alert, in order to display the relief posing the corresponding hazard; and

possibly (or as an option) before an alert, the marking of the intersection between the terrain and a “sliding” probe surface in order to display the line showing the geographical boundary of a corresponding potential hazard.

In the Scanned Sector, an instantaneous path of the airplane is defined, starting from the instantaneous position of the airplane, scanning the Scanned Sector over an aperture angle as described later and generating a reference surface.

FIG. 3 illustrates the horizontal projection 62 of this Scanned Sector which can be displayed on a screen. This horizontal projection 62 is bounded by an angular sector of angle V going from 10 to 360°, having as apex the representation of the aircraft A and being closed by a circular arc DE. This angular sector is scanned regularly with a center of rotation A so as to ascertain the neighboring overflown terrain at various times. The circular arc DE marks the horizontal scanned boundary beyond which the path of the aircraft is rendered highly random. The Scanned Sector is divided vertically into adjacent sectors of angle μ and having as common edge the vertical line passing through the instantaneous position of the aircraft. These adjacent sectors of angle p, which project horizontally as radials R. make it possible to reduce the relief and the alerting terrain areas to two dimensions. They also make it possible to display on the screen, at a given moment, a chosen portion of the horizontal projection of the Scanned Sector, called the Displayed Sector.

FIG. 3 illustrates a Displayed Sector 61 shown on a display device 55, preferably a display screen. The field 61 includes an apex A defining the current position of the aircraft. Two segments [AB] and [AC] forming an angle U define the Displayed Sector within the angular sector of the horizontal projection 62 of the Scanned Sector. This Displayed Sector 61 is able to present the terrain contours (also called the image background or map background) and the possible alert contours thanks to the “radials” R of angle μ, having a value of between 0.1° and 10°, preferably 0.35°.

The device aims to represent the Displayed Sector with different scales on the screen. These scales may be selected automatically and/or manually.

The Scanned Sector is firstly defined in order to detect the relief surrounding the airplane so as to present the pilot with a map background. The device thus allows an on-screen representation of the relief corresponding to a stagger in terms of altitude and providing a reference point in this gradation such as, for example, the current altitude of the airplane or the altitude of a runway.

FIG. 4 shows a vertical section of the relief in a radial of the Scanned Sector.

The relief Rf is shown by a solid line. It defines by computation a protection surface Sp which covers the relief Rf. A distance MTCD separates the relief Rf from the surface Sp representing a minimum terrain clearance distance denoted MTCD.

The relief is preferably represented by means of terrain cuts determined by parallel surfaces which intercept the representation of the relief. However, unlike the level curves, these surfaces are not necessarily horizontal, or plane. Thus, a terrain cut is represented by a surface SN3 according to one embodiment of the invention in FIG. 4 which will be described later. The surfaces SN1 to SN5 are parallel to the surface SN3 and form terrain cuts. The surfaces SN1 to SN5 delimit the terrain layers 1, 2, 3, 4 and 5 with a vertical stagger EV which will be defined later.

In the example in FIG. 4, the imaginary path TA of the airplane represents a reference surface used to fix the upper and lower boundaries of the terrain layers as indicated in table I of the annex. These terrain layer heights are in relation to the reference surface and are differentiated by colors according to a “color code”. The various terrain layer embodiments referred to below provide as a variant, terrain layer heights with respect to the reference of the ground, for example.

The vertical stagger EV therefore defines the relative positions of the terrain layers with respect to a reference surface.

In the example in FIG. 4, the terrain layer 3 comprises a reference surface called reference altitude of level 0: the upper boundary SN4 has an altitude of +500 feet for example above the reference altitude and a lower boundary corresponding to min (500 feet, MTCD). This lower boundary of this “reference terrain layer” allows the pilot to visualize, as reference to the imaginary path TA of the airplane, the terrain layer corresponding to a relative height of −500 feet, or to a minimum safety margin (MTCD) if this relative height MTCD is greater than −500 feet. The pilot sees the terrain layer with at least one minimum margin limited in all cases to −500 feet below the imaginary path of the airplane. The terrain layer 4 comprises an upper boundary corresponding to the lower boundary of the terrain layer 3 and a lower boundary of −1000 feet for example. Apart from these particular terrain layers and the layer 5 which does not have an upper boundary, the other layers have identical heights, for example 1000 feet.

In the currently preferred example of the invention, the color code is indicated in table II of the annex. The colors used are very high-density yellow, high-density yellow and medium-density yellow colors assigned to layers 1, 2 and 3 respectively and low-density and very low-density green colors assigned to layers 4 and 5 respectively. When the terrain cuts do not intersect the relief, the background of the screen is black, black being perceived as a non-alerting color.

In the currently preferred example of the invention, the code uses yellow and green colors which are suitable for a screen background and have quite a neutral character. The yellow color used, relatively dull on a black background, fills the highest terrain layers. The green color, more discreet than the yellow color used, fills the terrain layers lying below the yellow terrain layers. A progressive reduction in the density of the colors used for layers of lower and lower altitude makes it possible to show on the screen the altitudes of these layers with respect to the chosen reference, in this case with respect to the imaginary path TA. Thus, owing to the density and the character of the colors used, the pilot's attention is concentrated more on the layers lying above the imaginary path TA of the airplane.

Thus, the chosen gradation for rendering the altitudes comprises a color code based on a gradual shading of neutral colors.

According to a first option, this color code may use colors and densities different from those presented here. According to another option, the code may use only one density and a greater diversity of colors.

In a first embodiment of the invention, a terrain cut is defined by two surface sections which intersect. Thus, the cut SN3 in FIG. 4 will be described.

The first surface section SN3A of the cut SN3 is in this case a sector contained in a half-plane, which follows the predicted path of the aircraft over a distance corresponding to a chosen flight time, up to a point L3. Next, the second surface section SN3B has a less steep slope than the first section, approaching the horizontal. In fact, it is currently considered that the second surface section SN3B may be contained in a horizontal half-plane, with the shape of a truncated angular sector, which is joined to the surface section SN3A.

Of course, this is repeated over various levels so as to obtain the surfaces SN1 to SN5 as shown in FIG. 4. The points L of the various surfaces are in this case on the same vertical line, although they could be otherwise.

Likewise, although other solutions are possible, it is currently preferred for the vertical stagger EV of the cuts to be defined at the surface sections SN1B to SN5B. As regards truncated angular sectors, the surfaces SN1B to SN5B may be staggered on a grid of chosen pitch, for example by values which are multiples of 1000 feet. The base quantity for the stagger may be the geographical altitude, or the height of the ground, or even the vertical distance relative to the airplane. Moreover, even if the first sectors SN1A to SN5A are of variable axial slope, it is always possible for the distance between two sectors to be reduced to a vertical separation.

An imaginary path of the airplane, illustrated as TA, corresponds here to these surfaces SN1 to SN5. This imaginary path is composed of two surface sections (more generally two surface portions) defining the cut planes.

In the example described in FIG. 4, the points L correspond to 30 seconds of flight beyond the current position P of the airplane, while a warning is defined by a delay of 5 seconds and a caution is defined by a delay of 20 seconds.

Consequently, for a time slightly longer than the caution delay, the cuts corresponding to the “first surface section” are made in the direction of the instantaneous axis of the flight. It will be noted that this direction is that of the velocity vector of the airplane, if there is no acceleration component.

In this first embodiment of terrain cuts:

the “first surface section” tends to give advantage or favor to the short-term (30 second) display of the risks of a collision along a predicted path of the airplane based on the instantaneous velocity vector. In the example, the terrain is cut along a progressive descending oblique line;

in long term (after 30 seconds), the “second surface section” maps the relief assuming in practice that, at this long term, the vertical component of the velocity vector of the aircraft has been significantly reduced. In the example, the velocity vector is returned approximately to a horizontal plane. It should be pointed out that this long-term display of the terrain cuts is made horizontally with an altitude shift with respect to the instantaneous altitude of the aircraft. In the example in FIG. 4, the surface SN3 is brought up by its rise to the left to an altitude lying just beneath the airplane, whereas physically it is lower.

Thus the pilot perceives the relief according to a cutting rule which follows the estimated path of the airplane in its descent and then in a more horizontal flight. This rule provides the pilot with a display closer to reality than the previous cutting rule which followed the instantaneous path of the airplane. This indication results in a more meaningful display corresponding better to the pilot's sensation.

The lower part of FIG. 4a shows how, along a radial R of the Displayed Sector, the representation of the terrain cuts is made. The display attributes of the cuts are illustrated schematically by grades of grayness/hatching in the vertical cut. They are also along the radial at the bottom, but the attributes of the upper layers mask those of the lower layers. In practice, the display is multicolored, as seen previously.

Thus each “radial” corresponds to a vertical slice of the Scanned Sector 62. To it corresponds a radial of the Displayed Sector 61, the top being the position of the aircraft, which may or may not be illustrated on the screen. Radials of this kind are constructed in sufficient number to fill the Displayed Sector. The radials have a constant angular spacing μ.

According to a variant, the angular spacing μ may vary according to the position of the radials in the Displayed Sector. Thus, a smaller spacing may be defined around the path of the airplane so as to refine the display of the relief; in contrast, a larger spacing avoids too great a precision, unnecessary along the edges of the screen.

A second embodiment of the terrain cuts, which is a variant of the first one, will now be considered. In this second embodiment, the terrain cuts are made along horizontal surfaces having an altitude shift with respect to the airplane by a value denoted by DHA (Delta Height with respect to the Airplane), one formula of which, according to the invention, is given by the value of the vertical speed of the airplane multiplied by a time which may, for example, be 30 seconds. The direction of this DHA value is defined according to the direction of the vertical component of the instantaneous velocity vector of the airplane. Thus, when the airplane is descending, this DHA value simulates the coming-together altitudewise of the airplane and the relief which are displayed on the screen, thereby heightening the perception of a hazard by virtue of the map background when a risk of collision is indicated. The result is the same when the airplane is climbing.

It should be noted that, in the case of FIG. 4, this second embodiment amounts, for each cut such as SN3, to extending the horizontal “second surface section” SN3B to the left, beneath the aircraft, while eliminating the oblique “first surface section” SN3A. In this case, the DHA value may, for example, be proportional to the vertical component of the velocity vector, this being a linear function of this same vertical component of the velocity vector. It will also be noted that, in the airplane configuration in FIG. 4, this second embodiment gives the same result as the first.

In a third embodiment, the terrain cuts are at least partly approximately horizontal surfaces having an altitude shift with respect to the closest runway of value DHR (Delta Height with respect to the Runway) for a first chosen surface, having a value which varies for the other surfaces according to the chosen stagger, using for example a grid of chosen spacing corresponding to multiple values of 1000 feet in reference to the first surface of value DHR, and using the same color code to identify the terrain layers.

According to a first option, it is possible, as previously, to provide, for each cut, a “first surface section” parallel to the predicted path of the airplane and then a “second surface section” defined as indicated above.

In this way, the pilot perceives the relief according to a cutting rule which provides him with a display of the relief close to a runway, this display being useful especially in the case of landing.

In practice, a system may use only one of these embodiments or several of them, these being selected automatically and/or manually.

Thus, the aid module 4 is designed to determine terrain cuts over defined surfaces according to a cutting rule and the display module 5 is designed to display a map of the terrain cuts according to a chosen gradation for rendering the altitudes.

According to the first embodiment and a variant of the third embodiment of terrain cuts, the cutting rule comprises the construction of mutually parallel cut surfaces (SN1, SN2, SN3, SN4, SN5) according to a chosen vertical stagger and each consisting of a first surface defined along the direction of the instantaneous path TA of the aircraft, and then of a horizontal second surface.

According to the second embodiment and a variant of the third embodiment of terrain cuts, the cutting rule comprises the construction of mutually parallel cut surfaces (SN1, SN2, SN3, SN4, SN5) according to a chosen vertical stagger EV and each consisting of a horizontal surface.

According to one option of the embodiments of terrain cuts, the vertical stagger EV chosen is in relation to the instantaneous position at P of the aircraft. Preferably, the cut surfaces include a portion defined in relation to the instantaneous velocity of the aircraft. In addition, optionally the cut surfaces each comprise a surface defined partly in relation to the direction of the instantaneous velocity vector of the aircraft.

According to another option of the embodiments of terrain cuts, the vertical stagger EV chosen is in relation to the runway.

In the Scanned Sector, the aid module is defined to detect possible lines of collision with the relief, called alert line.

FIG. 4a is a more precise view of FIG. 4. In this vertical sectional view along a radial of the Scanned Sector, the airplane is in a position P at the time t0. Its path, here a descent in a straight line, makes an angle FPA with the horizontal. Around the relief RF (bold line), a protection surface Sp (fine line) is defined by computation. This surface may be defined in various ways, indicated schematically by a minimum terrain clearance distance denoted MTCD.

A standard avoidance limit path TE, also called evasion path or “probe”, starts from the current position P of the airplane. The probe is composed of two portions PM and MN. In FIG. 4a, the angle that the segment PM makes with the horizontal is chosen beforehand in order to be tied to the instantaneous velocity vector of the airplane at the point P. Its “sensitive” portion is a steep rise, of angle chosen in advance, which starts at a point M on the predicted path. As described with regard to the “sliding probe”, the point M can be moved along the predicted path until possibly encountering (that is to say if this is possible within the field of space scanned) the protection surface Sp tied to the relief at a point N. Perpendicular to the plane of the figure, the sliding probe sweeps the entire Scanned Sector defining a sheet of sliding probes. When a vertical avoidance maneuver is no longer possible, the lateral avoidance maneuver as defined above is recommended.

Thus, as the case may be, the points of encounter obtained during the sweep constitute a first sketch of a potential alert limit line. The role of the alert line is to make a prediction of the future (cautions or warnings), as will be seen. This alert line is displayed on the navigation screen preferably at most 120 seconds before the limit point after which the airplane will no longer be able to take its avoidance path. Beyond this, the Applicant considers at the present time that the prediction of the airplane's path is too error prone for the alert line to be relevant.

In the currently preferred example of the invention, the alert line is represented with a continuous yellow line of alerting character and of different density.

In the airplane configuration in FIG. 4a, the display of the radial will be supplemented with an alert line element AR, vertically below the point M where the sliding probe starts to touch the relief at the point N.

Thus, the aid module 4 is suitable for defining an evasion path TE, comprising an extension of the instantaneous path PM of the aircraft followed by a starting point M for an avoidance maneuver having a chosen component, as well as for defining a sheet of evasion paths by angular sweeping from the first one, in principle on either side of the latter. The avoidance maneuver selectively includes a vertical component (SVRM) with a corresponding angular sweep from 0° to ±30°, or a horizontal component (SHRM) with a corresponding angular sweep of 0° to ±90°.

It was indicated that the alert lines precede the caution and the warning. Away from the relief built up on the screen in the form of radials, the triggering of an alert also causes the location of representations of relief areas likely to result in a collision to appear.

Caution or warning situations will now be examined with respect to FIGS. 4a, 5 and 6:

if, in TPA, the sliding probe cuts the relief, for a distance MP whose travel time (or a related quantity) is less than the caution threshold (typically 20 seconds), the points of intersection considered (FIG. 5) form part of a caution volume, with the entire portion of the relief lying above the probe;

if, in TPB, the sliding probe cuts the relief for a distance MP whose travel time (or a related quantity) is less than the warning threshold (shorter, typically 5 seconds), the points of intersection considered (FIG. 6) form part of a warning volume, with the entire portion of the relief lying upstream of the probe and a downstream portion which is delimited as described below. A clear warning (with caution) is illustrated in FIG. 6.

The probes sweep the Scanned Sector so as to provide the alerting terrain areas, taking into account the minimum terrain clearance distance.

A clear caution (without a warning) is illustrated in FIG. 5. For a “caution” alarm, the terrain area lying between the two probes and bounded by the surface Sp is regarded as a “caution” alert area projected between the points A1 and A2 on a radial R. FIG. 5 also shows that the display symbolism in the caution area “supercedes” the relief indications.

FIG. 5A illustrates the detection of two repeated alert areas. In this case, the projected alert area is continuous along a radial R between the point A3 in the first alerting terrain area and the point A6 in the second alerting terrain area, so as to even out the detection of the relief over a close region of rugged relief. This evening-out of the relief makes it possible to simplify the display of the relief for the pilot and to give him the necessary information without unnecessary details.

In FIG. 6, a “warning” alert has been generated. In the currently preferred example of the invention, the delimitation of a “warning alert area” differs from the delimitation of a “caution alert area” seen above. The terrain area lying above the probe TPB (between the points B1 and B2) and above them, as well as the terrain area lying between the two probes along the line (B3-B4) and beyond, are regarded as a “warning” alert area. The remaining terrain area lying between the two probes is regarded as a “caution” alert area. These terrain areas are projected, with each time a specific display attribute, on the underlying radial R in the figure. This difference in the delimiting of areas makes it possible to overestimate the “warning” alert areas with respect to the delimitation used for the “caution” alert areas. This delimitation guarantees a safety margin for evaluation of the situation by the pilot.

In the currently preferred example of the invention, the alerting terrain areas are superimposed on the image background representing the overflown relief. According to another variant, the terrain areas may be displayed on a blank image background.

To detect the alerting terrain areas, FIGS. 5 and 6 show the effect of the “caution” probe TPA and the “warning” probe TPB associated with the surfaces CMT and CCT respectively, which are distinguished according to whether the maneuver is vertical (SVRM) or horizontal (SHRM). In fact, it is preferable in practice to make a distinction between:

an alarming terrain area for the “pull-up warning”; and

an alarming terrain area for the “avoid terrain warning”, with the aforementioned lateral avoidance path (SHRM) for example.

Table III of the annex shows the probes and the limit times at which certain types of alert are triggered when the probes detect a possible risk of collision.

Table III makes a distinction between the warning due to the vertical maneuver SVRM and that due to the horizontal maneuver SHRM; on the other hand, no distinction is made between the caution due to the vertical maneuver SVRM and that due to the horizontal maneuver SHRM. A variant of the invention would consist in also making this distinction, using different display messages and attributes in the two cases.

In a preferred embodiment, the prior alert areas are shown as areas filled with yellow color of alerting character, able to be distinguished from the relatively neutral yellow of the terrain layers; the “warning” alert areas are represented with the same texture on the screen, whatever their type: “avoid terrain” and “pull up”. In contrast, they may be distinguished by two variants of a striking (startling) color: the terrain area justifying the “pull up” warning is, for example, represented in 100% solid red; the terrain area justifying the “avoid terrain” warning is represented in the same example by an alternation of circularly arcuate bands colored 100% red and 100% black, each color being 2 mm in width for example. A variant consists in producing a red and black checkerboard. Another variant provides for the black to be replaced with another glaring color with red so as to produce a certain contrast for the pilot, especially white.

These color and shape differentiations according to the types of alert ensure that the pilot has a precise display of the situation of the airplane with its environment. This display optimizes the evaluation by the pilot and his decisions regarding the future path of the airplane.

Thus, the aid module 4 is designed to represent, on the display device 55 and after an alert of a certain type has been triggered, alerting terrain areas of corresponding type, these areas being delimited according to two types of evasion paths TPA and TPB and projected along radials R. More specifically and according to one particular aspect of the invention, the alerting terrain areas of caution type comprise a terrain area delimited between the evasion path TPA triggering a caution and the evasion path TPB triggering a warning.

More specifically and according to one particular aspect of the invention, the alerting terrain areas of warning type comprise a terrain area lying on the evasion path TPA between the points (B1) and (B2) and, beyond, a terrain area which lies between the two evasion paths TPA and TPB and is delimited along its lower edge by the horizontal segment [B4-B3].

According to another particular aspect of the invention, the aid module 4 is suitable for using different textures for the alerting terrain areas of “avoid terrain” warning and “climb” warning type.

According to one option, the texture is of solid red color in the case of the alerting terrain area of “climb” warning type.

According to one option, the texture is preferably of striking solid red color alternating with another color in the form of concentric circular bands in the case of the area of “avoid terrain” warning type.

According to one option, the texture is preferably of striking solid red color, doubly alternating with another color in the form of concentric circular and radial bands in the case of the area of “avoid terrain” warning type.

Another aspect of the invention will now be described with reference to FIGS. 3 and 7. The computations are carried out over a Scanned Sector 62 wider than the Displayed Sector 61. This allows anticipation over the change in the display, with the advance of the airplane, at least in certain cases.

The Applicant was tasked with the problem of making the pilot aware of information lying outside the Displayed Sector. One solution may be made in the manner which will now be described with reference to FIG. 7.

For the sake of clarity of the drawing, the Scanned Sector is shown at 180°, i.e. ±90° on each side of the instantaneous velocity vector of the airplane. In fact, its width may be modulated according to the situation of the airplane. For example, for a stable flight in a straight line, it is possible to take ±45° on each side of the instantaneous path axis of the airplane; in a turn, the sector may if necessary be extended angularly on the side where the airplane is going (for example a pronounced turn) and possibly reduced on the other side.

Taking into account the limited possibilities of display screens, the Displayed Sector will in general be narrower, both in terms of angular extent and in terms of range, than the Scanned Sector.

There may therefore be alert areas lying in the Scanned Sector, but outside the Displayed Sector. Similarly, the alert area is represented by a marking around the border of the Displayed Sector. At the present time, this is preferably made in the form of a narrow rectangle of fixed width (2 mm or 15 points) with the color corresponding to the type of alert. The length of the rectangle may be defined substantially as follows:

on the lateral border (RD1, FIG. 7), this length is equal to the linear extent of the alert area (on the screen);

on the end border (RE1, FIG. 7) this length is defined by the angular extent of the alert area (on the screen); and

in the RE2 case, a portion of the alert area is contained in the Displayed Sector. Similarly, the rectangle is limited to the non-visible portion of the alert area.

More generally, one starts from the non-visible portion of the alert area and takes its conformal (axial or radial) projection on the boundary of the Displayed Sector 61. Of course, it is possible to vary the dimensions and/or the appearance of the rectangle, depending on the alert, or on the type of screen for example. It is also possible to use forms other than a rectangle, for example a series of small circles or other symbolic figures.

These alert areas lying outside the chosen portion of the Scanned Sector and indicated on the border of the latter provide the pilot with the information necessary for him to decide on a maneuver to be performed independently of the information recommended on the alert areas lying within the chosen portion. This information provides the pilot with the essential data for deciding in complete safety on the path of the airplane so as to avoid a collision. Thus, a turn more suitable for the situation than a recommended vertical avoidance maneuver could be envisioned if no alert area is displayed at the boundary of the chosen portion of the Scanned Sector along the path of the turn.

Thus, the display module 4 is designed to drive a display screen so as to display a portion, delimited between ±45° and ±90° according to the situation of the airplane, of the Scanned Sector 61 and said possible alerting terrain areas.

According to another aspect of the invention, the display module 5 is designed to indicate in a different manner, on the one hand, a possible alerting terrain area in the delimited portion of the Scanned Sector 61 and, on the other hand, a possible alerting terrain area RE1 lying outside this chosen portion of the Scanned Sector 61.

More specifically, the display of a possible alerting terrain area lying outside the delimited portion of the Scanned Sector 61 comprises at least one display of an alerting terrain area on the boundaries of said portion of the Scanned Sector 61.

According to a first option, the display of an alerting terrain area on the boundaries of said delimited portion of the Scanned Sector comprises a display rectangle RE1. More specifically, the display rectangle RE1 has a fixed width, a length dependent on that of the relief of the hazardous surface and a color dependent on the type of possible collision alert.

We will now return to the representation of the alert lines, which may serve to anticipate a possible caution. A person skilled in the art will understand that many alert lines may appear at the same time on the screen in certain cases, and in a disordered manner, at least in terms of appearance. FIGS. 8 and 8a illustrate modifications that may be made to the alert lines in order to avoid this.

It may happen that several alert lines are obtained at the same time, either for different portions of the relief, or for different degrees of potential future alert or for different probes (SVRM or SHRM), for example. In principle, there are always two alert lines, one corresponding to a future caution and the other to a future warning. However, the caution alert line may be the only one displayed, if the other one is off screen. When the two caution/warning alert lines can be displayed for the same risk, the procedure is as follows:

a) the alert lines are displayed according to the result of a comparison between a value ALT defining a duration and threshold values of durations Tai, i varying from 1 to 3. The ALT value is defined as:

ALT=distance between the airplane and the alert line/speed of the airplane with respect to the ground, said line and said speed being considered along the predicted path of the airplane. The results are presented in the annex in table IV in which:

Ta1 preferably takes a value of 600 seconds,

Ta2 preferably takes a value of 20 seconds,

Ta3 preferably takes a value of 5 seconds. A single alert line is thus displayed at a time as a function of the time which separates the airplane from the limit point beyond which the airplane will no longer be able to take its avoidance path;

b) the alert lines are preferably displayed on the upper edge of the screen, furthest away from the representation of the airplane; and

c) in principle, the alert lines are omitted should there be a caution or a warning.

As illustrated in FIGS. 8 and 8a and according to the invention, the alert lines are delimited by radials reduced to portions of radials, called “lugs” E. The screen length of these portions of radials may take the value e, for example 5.15 mm, i.e. 25 lines in the direction of moving away from the representation of the airplane at P.

In the currently preferred example of the invention, as indicated in FIG. 8, the ends of the alert lines L′1 and L′2 lying on the same radial are joined together if they satisfy one of the following conditions:

the distance r between the points on the same radial does not exceed a chosen value, for example 2 NM; or

the distance r between the points on the same radial does not exceed 2 mm on the display screen for ranges of less than 80 NM.

In the other cases of the currently preferred example of the invention, the portions of radials are separate. Depending on whether the alert line is respectively remote from or close to the representation of the airplane, the lug is respectively in the direction of moving closer to the representation of the airplane or in the direction of moving away from the representation of the airplane.

FIG. 8a shows three alert lines corresponding to the currently preferred example of the invention for indicating their portions of radials. Thus, the alert lines L1 and L2 lying on the same radial do not meet the necessary conditions in order to be joined by the portion T12. In addition, the alert lines L2 and L3 do not have common radials and each possesses a respective portion of a radial T2 and T3.

Thus, the alert lines are more easily interpreted by the pilot.

As illustrated in FIG. 9, the distance on the screen between the representation of the airplane and a possible alert line causes their juxtaposition or their intersection. To remedy this drawback, a chosen minimum distance on the screen is imposed between the representation of the airplane and an alert line. Any alert line LA detected over a distance of less than this minimum value is represented by a circular arc LC around the representation of the airplane.

In a variant of the invention, this chosen minimum value varies according to the angle of the radial.

In addition, the horizontal angular sector of the scanning area of the probes is preferably limited for the alert lines at ±30° on either side of the straight-line path of the airplane. This makes it possible to limit the inopportune alerts in standard approach corridors.

Thus, the aid module 4 is capable of detecting the intersection N of the relief Sp with the evasion path TE and then of causing the selective triggering of alerts according to the estimated time between the instantaneous position of the aircraft P and the starting point M of an avoidance maneuver. More specifically, the alerts comprise a caution triggered for the estimated time of 20 seconds and a warning triggered for the estimated time of 5 seconds.

According to one characteristic of the invention, the display module 5 is suitable for representing, in a chosen mode, a single type of alert line at a time, detected by the intersection of the evasion path sheet with the relief Sp.

According to a first aspect, the chosen mode comprises the reduction of the portions E of radials delimiting said alert lines at their ends.

According to another aspect, the chosen mode comprises the joining of portions of radials between two alert lines L′1 and L′2 each having a portion of a radial lying on the same radial, said joining being made after verification of a criterion. More specifically, the criterion comprises the fact that the distance (r) between any two points on a portion of the same radial does not exceed a predefined value, especially 2 NM.

According to another aspect, the chosen mode comprises the display of an alert line LA having a rounded shape LC around the aircraft P when a distance having a minimum predetermined value is not respected between said alert lines LA and the aircraft P which is displayed on said medium.

According to another aspect, the chosen mode comprises an angular sector chosen for displaying the alert lines. More specifically, the chosen angular sector is between approximately ±10° and ±90°.

These modifications allow optimum analysis by the pilot of the information relating to the alert lines.

In situations such as takeoff and landing, the alerts may represent for the pilot spurious information on certain parts of the screen. Similarly, EP-A-0 989 386 provides for the CPA mode to be completely inhibited, hence resulting in complete inhibition of the alerts. It has turned out that this method is not always satisfactory. The invention remedies this problem.

In the case of takeoff, one solution consists in partially inhibiting the alert lines by suppressing them around the path of the airplane along an angular sector of, for example, ±15°.

Thus, the neighboring portions of the predicted path TA of the aircraft comprise an angular sector, in the plane of the path of the aircraft, having an apex angle U of between about ±10° and ±45° about the predicted path of the aircraft of the aircraft in the detected takeoff phase. More specifically, the apex angle U is about ±15°.

This is because complete inhibition of the alert lines in the takeoff phase, as proposed in the prior technique, would cause a sudden appearance of these lines at the restart of the CPA mode and could distract the pilot.

In the case of landing, a partial inhibition of the alert lines is also proposed. These alert lines are suppressed around the path of the airplane over a predefined angular sector. Two values of this angular sector are on option according to the altitude of the airplane with respect to the runway.

The airplane must firstly meet the following criteria:

the height of the airplane above the runway must be less than a predetermined value, preferably 3500 feet;

the vertical speed of the airplane must be less than a predetermined value, preferably 2000 feet/min.

In the currently preferred example of the invention., if the horizontal distance between the airplane and the threshold of the runway is between two predefined values (between 7 and 15 NM), then the angular sector in which the alert lines are inhibited is, for example, ±15°.

In the currently preferred example of the invention, if the horizontal distance between the airplane and the threshold of the runway is less than a predetermined value (for example 7 NM), then the angular sector in which the alert lines are inhibited is, for example, ±30°.

Thus, the neighboring portions of the predicted path TA of the aircraft comprise an angular sector, in the plane of the path of the aircraft, having an apex angle U of between about ±10° and ±45° about the aircraft-runway axis in the detected landing phase in the case of an approach criterion for a validated landing runway. This approach criterion comprises a defined height of the airplane above the landing runway and a chosen speed of the airplane. More specifically, the apex angle U is about ±15° for a horizontal distance between the airplane and the threshold of the landing runway of between about 7 NM and about 15 NM.

More specifically, the apex angle U is about ±30° for a horizontal distance between the airplane and the threshold of the landing runway of between about 2.7 NM and about 7 NM.

These two conditions are chosen independently or taken in combination so as to progressively inhibit the alert lines around the path of the airplane and so as not to disturb the pilot by a sudden disappearance of these lines. The increase in the value of the inhibition sector in the runway approach phase allows the information on the screen to be reduced but the more essential information to be retained. Otherwise, the pilot may be distracted by the appearance of alert lines which intersect the path of the airplane.

During these takeoff and landing phases, the invention provides a uniform presentation in black of just the terrain layers close to the runway according to a certain criterion.

The proximity of the runway is defined when two conditions are combined:

the height of the airplane above the runway must be less than a predetermined value, preferably 3500 feet;

the distance between the aircraft and the closest runway must be less than a predetermined threshold (for example 15 NM).

The criterion proposes that the lowest point of the layer in question must be below a predetermined height with respect to the runway.

In the prior technique, the inhibition of the CPA mode caused the uniform presentation in black of the various terrain layers represented on the image background in the takeoff or landing phase. This technique made the terrain layers suddenly disappear upon complete inhibition of the CPA mode and made the terrain layers suddenly reappear upon resumption of the CPA mode. In the takeoff or landing phases, for the comfort and calmness of the pilot when taking decisions, it is preferable that only the runway and its environs be presented as non-alert areas, as proposed according to the invention, and that the rest of the terrain layers remain visible. As a variant, the runway may be indicated in yellow on the screen background according to the invention. Since this yellow is a bright color without being alerting, the representation of the runway thus delimits the area of interest to the pilot during a takeoff or landing phase.

Thus, the display module 5, designed to cooperate with the aid module 4 so as to display 55 a two-dimensional representation of the relief over a display field 61 is capable of inhibiting certain portions of this representation according to a condition comprising the fact that the lowest point of each of these portions is below a chosen height and that an aircraft-runway proximity criterion is validated. More specifically, said proximity criterion comprises the fact that the aircraft height with respect to the closest runway is below a predetermined threshold and the fact that the horizontal distance between the aircraft and the closest runway is below a predetermined threshold.

Of course, the various aspects of the invention may be applied independently of one another, or taken in combination.

The system involves throughout the description an aid module and a display module which cooperate in order together to produce various aspects of the invention. Of course, the distribution of the functions between the aid module and the display module may vary according to the implementation choices within the competence of a person skilled in the art. All or almost all of the functions may be implanted in the aid module or the display module, the latter possibly being restricted to the screen. A product according to the invention does not necessarily contain the screen. In addition, the aid and display modules are regarded as virtual objects not limited to merely the elements of which they are made up in the description.

The invention is not limited to a system applicable just to airplanes. Thus, the proposed navigation aid according to the invention may be integrated into the equipment of other aircraft of the helicopter type, making a few adaptations within the competence of a person skilled in the art.

### ANNEX

TABLE I

| Terrain | |
|---|---|
| layer number | Description |
| 1 | Upper boundary: none |
| | Lower boundary: +1500 feet |
| 2 | Upper boundary: +1500 feet |
| | Lower boundary: +500 feet |
| 3 | Upper boundary: +500 feet |
| | Lower boundary: −min (500 feet, MTCD) |
| 4 | Upper boundary: −min (500 feet, MTCD) |
| | Lower boundary: −1000 feet |
| 5 | Upper boundary: −1000 feet |
| | Lower boundary: −2000 feet |

The altitude reference 0 corresponds to the imaginary path of the aircraft in the currently preferred example of the invention.

TABLE II

| Terrain | | |
|---|---|---|
| layer number | Color | Density |
| 1 | Yellow | Very high density |
| 2 | Yellow | High density |
| 3 | Yellow | Medium density |
| 4 | Green | Low density |
| 5 | Green | Very low density |

TABLE III

| | | |
|---|---|---|
| Probe | Limit time | Alert |

| (maneuver) | (seconds) | English | French |
|---|---|---|---|
| SVRM | 5 | pull-up | cabrer |
| SVRM | 20 | caution | pré-alarme |
| SHRM | 5 | avoid terrain | éviter terrain |
| SHRM | 20 | caution | pré-alarme |

TABLE IV

| Criterion | Display |
|---|---|
| ALT > Ta1 | No alert line displayed |
| Ta1 > ALT > Ta2 | Caution alert line displayed |
| Ta2 > ALT > Ta3 | Warning alert line displayed |
| Ta3 > ALT | No alert line displayed |

1. An air navigation aid system, intended to be on board an aircraft and comprising:
an input (2) for receiving static and dynamic parameters of the aircraft;
an aid module (4) designed to use said parameters and at least one overflown terrain relief database (3) so as to extract (40) relief information about a three-dimensional scanned field, defined according to the path of the aircraft, and to generate possible alerting information (51; 42) corresponding to a risk of collision between the aircraft and the relief, depending on at least one predicted path of the aircraft; and
a display module (5) designed to cooperate with the aid module (4) so as to display (55) a two-dimensional representation of the relief on a displayed field and to insert thereinto a possible alert signal, characterized in that the aid module (4) is designed to establish a detected takeoff and/or landing phase state (41), and to cooperate with the display module (5) so as to selectively inhibit the possible alert signal over defined portions of the field displayed, in detected takeoff and/or landing phase.

2. The system as claimed in claim 1, characterized in that the alerts comprise cautions and warnings.

3. The system as claimed in claim 2, characterized in that the alerts comprise predictive indications about future warnings or cautions.

4. The system as claimed in one of claims 1 to 3, characterized in that the defined portions of the displayed field (61) comprise neighboring portions of the predicted path of the aircraft.

5. The system as claimed in claim 4, characterized in that the neighboring portions of the predicted path (TA) of the aircraft comprise an angular sector, in the plane of the path of the aircraft, having an apex angle (U) of between about +10° and ±45° about the predicted path of the aircraft of the aircraft in the detected takeoff phase.

6. The system as claimed in claim 5, characterized in that the apex angle (U) is about ±15°.

7. The system as claimed in one of claims 4 to 6, characterized in that the neighboring portions of the predicted path (TA) of the aircraft comprise an angular sector, in the plane of the path of the aircraft, having an apex angle (U) of between about ±10° and ±45° about the aircraft-runway axis in the detected landing phase in the case of an approach criterion for a validated landing runway.

8. The system as claimed in claim 7, characterized in that the approach criterion comprises a defined height of the airplane above the landing runway and a chosen speed of the airplane.

9. The system as claimed in claims 7 and 8, characterized in that the apex angle (U) is about ±15° for a horizontal distance between the airplane and the threshold of the landing runway of between about 7 NM and about 15 NM.

10. The system as claimed in one of claims 7 to 9, characterized in that the apex angle (U) is about ±30° for a horizontal distance between the airplane and the threshold of the landing runway of between about 2.7 NM and about 7 NM.

11. The system as claimed in claim 1, characterized in that the defined portions of the displayed field (61) comprise neighboring portions of a displayed landing/takeoff runway.

12. The system as claimed in claims 1 to 11, in which the display module (5), designed to cooperate with the aid module (4) so as to display (55) a two-dimensional representation of the relief in a displayed field (61), characterized in that the display module (5), designed to cooperate with the aid module (4), is capable of inhibiting certain portions of this representation according to a condition comprising the fact that the lowest point of each of these portions is below a chosen height and that an aircraft-runway proximity criterion is validated.

13. The system as claimed in claim 12, characterized in that said proximity criterion comprises the fact that the aircraft height with respect to the closest runway is below a predetermined threshold and the fact that the horizontal distance between the aircraft and the closest runway is below a predetermined threshold.

14. The system as claimed in claims 1 to 13, characterized in that the display module (5) is designed to cooperate with the aid module (4) so as to display (55) the runway in a specific color in a landing/takeoff phase of the aircraft.

15. The system as claimed in one of the preceding claims, characterized in that the aid module (4) is designed to determine terrain cuts over defined surfaces according to a cutting rule and in that the display module (5) is designed to display a map of the terrain cuts according to a chosen gradation for rendering the altitudes.

16. The system as claimed in claim 15, characterized in that the cutting rule comprises the construction of mutually parallel cut surfaces (SN1, SN2, SN3, SN4, SN5) according to a chosen vertical stagger and each consisting of a first surface defined along the direction of the instantaneous path (TA) of the aircraft, and then of a horizontal second surface.

17. The system as claimed in claim 15, characterized in that the cutting rule comprises the construction of mutually parallel cut surfaces (SN1, SN2, SN3, SN4, SN5) according to a chosen vertical stagger (EV) and each consisting of a horizontal surface.

18. The system as claimed in one of claims 15 to 17, characterized in that the vertical stagger (EV) chosen is in relation to the instantaneous position at (P) of the aircraft.

19. The system as claimed in one of claims 15 to 18, characterized in that the cut surfaces include a portion defined in relation to the instantaneous velocity of the aircraft.

20. The system as claimed in one of claims 15 to 19, characterized in that the cut surfaces each comprise a surface defined partly in relation to the direction of the instantaneous velocity vector of the aircraft.

21. The system as claimed in one of claims 15 to 17, characterized in that the vertical stagger (EV) chosen is in relation to the runway.

22. The system as claimed in claims 15 to 21, characterized in that the chosen gradation for rendering the altitudes comprises a color code based on a gradual shading of neutral colors.

23. The system as claimed in one of the preceding claims, characterized in that the aid module (4) is suitable for defining an evasion path (TE), comprising an extension (PM) of the instantaneous path of the aircraft followed by a starting point (M) for an avoidance maneuver having a chosen component, as well as for defining a sheet of evasion paths by angular sweeping from the first one.

24. The system as claimed in claim 23, characterized in that the avoidance maneuver includes a vertical component (SVRM).

25. The system as claimed in claim 23, characterized in that the avoidance maneuver includes a horizontal component (SHRM).

26. The system as claimed in one of claims 23 to 25, characterized in that the aid module (4) is capable of detecting the intersection of the relief (Sp) with the sheet of evasion paths (TE) and then of causing the selective triggering of alerts according to the estimated time between the instantaneous position (P) of the aircraft and the starting point (M) of an avoidance maneuver.

27. The system as claimed in one of claims 21 to 26, characterized in that the alerts comprise a caution triggered for the estimated time of 20 seconds and a warning triggered for the estimated time of 5 seconds.

28. The system as claimed in one of claims 21 to 27, characterized in that the alerts include predictive indications about future warnings or cautions, these indications being called alert lines.

29. The system as claimed in one of claims 23 to 28, characterized in that the display module (5) is suitable for representing, in a chosen mode, a single type of alert line at a time.

30. The system as claimed in claim 29, characterized in that said chosen mode comprises the reduction of the portions (E) of radials delimiting said alert lines at their ends.

31. The system as claimed in either of claims 29 and 30, characterized in that said chosen mode comprises a joining of portions of radials between two alert lines (L′1 and L′2) each having a portion of a radial lying on the same radial, said joining being made after verification of a criterion.

32. The system as claimed in one of claims 29 to 31, characterized in that said criterion comprises the fact that the distance (r) between any two points on a portion of the same radial does not exceed a predefined value, especially 2 NM.

33. The system as claimed in one of claims 29 to 32, characterized in that said chosen mode comprises the display of an alert line (LA) having a rounded shape (LC) around the aircraft (P) when a distance having a minimum predetermined value is not respected between said alert lines (LA) and the aircraft (P) which is displayed on said medium.

34. The system as claimed in one of claims 29 to 33, characterized in that said chosen mode comprises an angular sector chosen for displaying the alert lines.

35. The system as claimed in claim 34, characterized in that said chosen angular sector is between approximately ±10° and ±90°.

36. The system as claimed in one of the preceding claims, characterized in that the aid module (4) is designed to represent, on the display device (55) and after an alert of a certain type has been triggered, alerting terrain areas of corresponding type, these areas being delimited according to two types of evasion paths (TPA and TPB) and projected along radials (R).

37. The system as claimed in claim 36, characterized in that the alerting terrain areas of caution type comprise a terrain area delimited between the evasion path (TPA) triggering a caution and the evasion path (TPB) triggering a warning.

38. The system as claimed in either of claims 36 and 37, characterized in that the alerting terrain areas of warning type comprise a terrain area lying on the evasion path (TA) between the points (B1) and (B2) and, beyond, a terrain area which lies between the two evasion paths (TPA) and (TPB) and is delimited along its lower edge by the horizontal segment [B4-B3].

39. The system as claimed in one of claims 36 to 38, characterized in that the aid module (4) is suitable for using different textures for the alerting terrain areas of “avoid terrain” warning and “climb” warning type.

40. The system as claimed in claim 39, characterized in that said texture is of solid red color in the case of the alerting terrain area of “climb” warning type.

41. The system as claimed in either of claims 39 and 40, characterized in that said texture is preferably of striking solid red color alternating with another color in the form of concentric circular bands in the case of the area of “avoid terrain” warning type.

42. The system as claimed in either of claims 39 and 40, characterized in that said texture is preferably of striking solid red color, doubly alternating with another color in the form of concentric circular and radial bands in the case of the area of “avoid terrain” warning type.

43. The system as claimed in either of claims 41 and 42, characterized in that said other color is preferably black.

44. The system as claimed in either of claims 41 and 42, characterized in that said other color is preferably white.

45. The system as claimed in one of the preceding claims, characterized in that the display module (4) is designed to drive a display screen so as to display a portion, delimited between ±45° and ±90° according to the situation of the airplane, of the Scanned Sector (61) and said possible alerting terrain areas.

46. The system as claimed in claim 45, characterized in that the display module (5) is designed to indicate in a different manner, on the one hand, a possible alerting terrain area in the delimited portion of the Scanned Sector (61) and, on the other hand, a possible alerting terrain area (RE1) lying outside this chosen portion of the Scanned Sector (61).

47. The system as claimed in either of claims 45 and 46, characterized in that the display of a possible alerting terrain area lying outside the delimited portion of the Scanned Sector (61) comprises at least one display of an alerting terrain area on the boundaries of said portion of the Scanned Sector (61).

48. The system as claimed in one of claims 45 to 47, characterized in that the display of an alerting terrain area on the boundaries of said delimited portion of the Scanned Sector comprises a display rectangle (RE1).

49. The system as claimed in claim 48, characterized in that said display rectangle (RE1) has a fixed width, a length dependent on that of the relief of the hazardous surface and a color dependent on the type of possible collision alert.
